(19) United States
(12) Patent Application Publication
(10) Pub. No.: US 2020/0175259 A1
(43) Pub. Date: Jun. 4, 2020

(54) FACE RECOGNITION METHOD AND APPARATUS CAPABLE OF FACE SEARCH USING VECTOR

(71) Applicant: Electronics and Telecommunications Research Institute, Daejeon (KR)

(72) Inventors: Jong-Hyouk NOH, Daejeon (KR); Seok Hyun KIM, Daejeon (KR); Soo Hyung KIM, Daejeon (KR); Seung-Hyun KIM, Daejeon (KR); Youngsam KIM, Daejeon (KR); Kwantae CHO, Daejeon (KR); Sangrae CHO, Daejeon (KR); Young Seob CHO, Daejeon (KR); Jin-Man CHO, Daejeon (KR); Seung Hun JIN, Daejeon (KR)

(73) Assignee: Electronics and Telecommunications Research Institute, Daejeon (KR)

(21) Appl. No.: 16/583,343

(22) Filed: Sep. 26, 2019

(30) Foreign Application Priority Data
Dec. 3, 2018 (KR) 10-2018-0153917

(51) Int. Cl. G06K 9/00; G06K 9/62; G06T 7/11

(52) U.S. Cl. CPC G06K 9/00281; G06K 9/00275; G06T 7/11; G06K 9/00288; G06K 9/6232

(57) ABSTRACT

A facial recognition method and apparatus are provided. The face recognizing apparatus divides an input face image into a plurality of regions, generates a feature vector consisting of real values for each region of the input face image, and generates an image feature vector using the generated feature vectors for each region. In addition, the face recognizing apparatus performs a search for finding whose face image the input face image is by using the image feature vector.

### CROSS-REFERENCE TO RELATED APPLICATION

This application claims priority to and the benefit of Korean Patent Application No. 10-2018-0153917 filed in the Korean Intellectual Property Office on Dec. 3, 2018, the entire contents of which are incorporated herein by reference.

### BACKGROUND OF THE INVENTION

### (a) Field of the Invention

The present disclosure relates to face recognition, and more particularly, to a method and apparatus for performing face recognition and face search by processing an image.

### (b) Description of the Related Art

Recently, face recognition performance has been dramatically improved due to deep learning technology, which is a method of machine learning, and the face recognition technology using deep learning has been applied in various fields such as a mobile terminal lock function and access control. Although the face recognition technology using deep learning is mainly utilized for face authentication, it is also being studied in the field of searching for an owner of a face in a mass database.

Face images are affected by many factors, including camera type, time of day, background, and facial angle. In addition, various facial expressions and various ornaments such as glasses, sunglasses, and earrings affect face recognition. These various factors make face authentication and face search difficult for face recognition.

A face recognition method extracts a feature vector from an input face image, compares it with a feature vector of a registered face image to calculate a similarity, and performs face recognition based on the similarity.

However, due to the variety of face images making face authentication and face search difficult in face recognition, there is still a difficulty in face recognition and face search not occurring correctly.

Related prior art documents include “Feature Vector Extraction Method and Apparatus for Face Recognition and Search” described in Korean Patent Application Publication No. 2004-0034342.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present disclosure has been made in an effort to provide a method and apparatus for recognizing a face even when a part of the face image is masked by an object such as ornaments.

In addition, the present disclosure has been made in an effort to provide a method and apparatus that can efficiently search for a face while reducing the search time in a large face database for face recognition.

An exemplary embodiment of the present disclosure provides a method of performing face recognition. The method includes: dividing, by a face recognizing apparatus, an input face image into a plurality of regions; and generating, by the face recognition apparatus, a feature vector consisting of real values for each region of the input face image, and generating an image feature vector using the generated feature vectors for each region.

In an implementation, the generating of an image feature vector may include generating an image feature vector by using a deep learning model including a plurality of division models that receive images corresponding to each of the plurality of divided regions of the face image as region images and generate a feature vector for each region image, and a concatenation model that performs learning with outputs of the division models to output a mixed feature vector corresponding to the face image, wherein the image feature vector may include feature vectors for the region images of the divided regions and the mixed feature vector.

In an implementation, the method may further include: generating, by the face recognition apparatus, a quantization feature vector consisting of a bit string by quantizing the image feature vector; finding, by the face recognition apparatus, a candidate group by searching a database using the quantization feature vector; and performing, by the face recognition apparatus, a detailed search for finding a class indicating whose face image the input face image is by using the feature vectors included in the searched candidate group and the image feature vector.

In an implementation, in the finding of a candidate group and in the performing of a detailed search, a search may be performed based on a similarity calculation between a quantization feature vector or an image feature vector corresponding to the input face image and feature vectors stored in the database, and the similarity calculation may be performed for each region.

In an implementation, when calculating similarities between the quantization feature vector or the image feature vector and the feature vectors stored in the database, a similarity between feature vectors may be calculated for each region, a similarity for each region is obtained by using a weight selectively assigned to the calculated similarity, and a final similarity may be obtained by summing the similarity for each region, wherein the weight may be selectively assigned for each region according to a degree to which a corresponding region is masked.

In an implementation, the finding of a candidate group may include selecting, as a candidate group, a group having a highest similarity to the quantization feature vector of the input face image from a cluster mapping table in which a plurality of face images are grouped based on quantization feature vectors.

In an implementation, the cluster mapping table may include a representative vector assigned to each group and a belonging vector mapping to the representative vector and representing a serial number of face images belonging to a corresponding group, wherein the representative vector may include one of quantization feature vectors of the plurality of face images. The selecting a group, as a candidate group, may include calculating a similarity between the representative vector of each group and the quantization feature vector of the input face image, respectively, and selecting a representative vector having a highest similarity as the candidate group based on the similarity calculation result for each representative vector of each group.

In an implementation, the performing of a detailed search may include finding an image feature vector having a highest similarity to the image feature vector of the input face image among image feature vectors corresponding to serial numbers included in the candidate group from a feature vector table in which image feature vectors of the plurality of face images are mapped to serial numbers.

In an implementation, the feature vector table may be mapped to a class corresponding to the serial number and the class represents whose face image a corresponding face image is, and the performing of a detailed search may include performing similarity calculation between the image feature vectors corresponding to the serial numbers included in the candidate group and the image feature vector of the input face image, respectively, and selecting a class mapped to an image feature vector corresponding to a serial number having a highest similarity based on the result of the similarity calculation.

In an implementation, the generating of a quantization feature vector may include performing a quantization process that converts a value of a feature vector into “1” or “0” according to whether the value of the feature vector is included in a section by using a plurality of sections set in advance for each feature vector included in the image feature vector.

In an implementation, one feature vector may be composed of real values in a d-dimension, a plurality of sections may be determined for each term constituting the real value, and a value of the term may be converted into bits by using the sections determined for each term in the quantization process.

In an implementation, one term may be divided into a plurality of sections, and a threshold may be set for each section so that a distribution of data for each term constituting the feature vector may be a discrete uniform distribution.

Another embodiment of the present disclosure provides an apparatus for performing face recognition. The apparatus includes: an input interface device configured to receive a face image; a storage device configured to include a database; and a processor configured to perform face recognition processing on a face image provided from the input interface device, wherein the processor is configured to divide the provided face image into a plurality of regions and generate a feature vector consisting of real values for each region of the provided face image, and generate an image feature vector using the generated feature vectors for each region.

In an implementation, the processor may be configured to generate the image feature vector by using a deep learning model including a plurality of division models that receive images corresponding to each of the plurality of divided regions of the provided face image as region images and generate a feature vector for each region image, and a concatenation model that performs learning with outputs of the division models to output a mixed feature vector corresponding to the provided face image, wherein the image feature vector may include feature vectors for the region images of the divided regions and the mixed feature vector.

In an implementation, the processor may be further configured to generate a quantization feature vector consisting of a bit string by quantizing the image feature vector, find a candidate group by searching the database using the quantization feature vector, and perform a detailed search for finding a class indicating whose face image the provided face image is by using the feature vectors included in the searched candidate group and the image feature vector.

In an implementation, the processor may be specifically configured to perform a search based on a similarity calculation between a quantization feature vector or an image feature vector corresponding to the provided face image and feature vectors stored in the database, and the similarity calculation is performed for each region.

In an implementation, the processor may be specifically configured to, when calculating similarities between the quantization feature vector or the image feature vector and the feature vectors stored in the database, calculate a similarity between feature vectors for each region, obtain a similarity for each region by using a weight selectively assigned to the calculated similarity, and obtain a final similarity by summing the similarity for each region, wherein the weight may be selectively assigned for each region according to a degree to which a corresponding region is masked.

In an implementation, the database may include a cluster mapping table in which a plurality of face images are grouped based on quantization feature vectors, and a feature vector table in which the image feature vectors of the plurality of face images are mapped to serial numbers. The cluster mapping table may include a representative vector assigned to each group and a belonging vector mapping to the representative vector and representing a serial number of face images belonging to a corresponding group, wherein the representative vector includes one of quantization feature vectors of the plurality of face images. The feature vector table may be further mapped to a class corresponding to the serial number, and the class represents whose face image a corresponding face image is.

In an implementation, the processor may be specifically configured to calculate a similarity between the representative vector of each group in the cluster mapping table and the quantization feature vector of the input face image, respectively, select a representative vector having a highest similarity as the candidate group based on the similarity calculation result for each representative vector of each group, perform similarity calculation between the image feature vectors corresponding to the serial numbers included in the candidate group based on the feature vector table and the image feature vector of the input face image, respectively, and select a class mapped to an image feature vector corresponding to a serial number having a highest similarity based on the result of the similarity calculation.

In an implementation, the processor may be specifically configured to perform a quantization process that converts a value of a feature vector into “1” or “0” according to whether the value of the feature vector is included in a section by using a plurality of sections set in advance for each feature vector included in the image feature vector, wherein one feature vector may be composed of real values in the d-dimension, a plurality of sections are determined for each term constituting the real value, and a value of the term may be converted into bits by using the sections determined for each term in the quantization process.

### BRIEF DESCRIPTION OF THE DRAWINGS

FIG. 1 is an exemplary diagram illustrating obtaining a feature vector for face recognition according to an embodiment of the present disclosure.

FIG. 2 is an exemplary view illustrating an image feature vector according to an exemplary embodiment of the present disclosure.

FIG. 3 is an exemplary view illustrating a quantization process according to an embodiment of the present disclosure.

FIG. 4 is an exemplary diagram illustrating a cluster mapping table and a feature vector table according to an embodiment of the present disclosure.

FIG. 5 is a diagram illustrating a structure of a face recognition apparatus according to an exemplary embodiment of the present disclosure.

FIG. 6 is a flowchart illustrating a face recognition method according to an exemplary embodiment of the present disclosure.

FIG. 7 is a diagram illustrating a structure of a face recognition apparatus according to another embodiment of the present disclosure.

### DETAILED DESCRIPTION OF THE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising” will be understood to imply the inclusion of stated elements but not the exclusion of any other elements.

The expressions described in the singular may be interpreted as singular or plural unless an explicit expression such as “one”, “single”, and the like is used.

Hereinafter, a face recognition method and apparatus according to an exemplary embodiment of the present disclosure will be described.

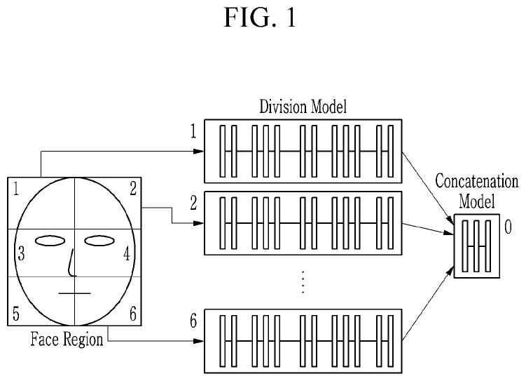

FIG. 1 is an exemplary diagram illustrating obtaining a feature vector for face recognition according to an embodiment of the present disclosure.

In an embodiment of the present disclosure, a face image is divided into a plurality of regions, and face recognition processing is performed based on the divided regions (hereinafter referred to as a face region for convenience of description).

For example, as shown in FIG. 1, the face image is divided into six regions. The number of regions can vary by implementation. The regions depend on the person's face, face angle, and so on. When the face image is divided into regions, the face image may be divided based on eyes and a mouth found using a face detection algorithm.

In an embodiment of the present disclosure, a face image is divided into a plurality of regions, and face recognition is performed based on the plurality of regions.

For face recognition or face authentication, a feature vector value must be extracted from the image information. In an embodiment of the present disclosure, feature vector values and total feature vector values for divided regions are extracted.

In order to obtain a feature vector for a face image, a deep learning model may be used in an embodiment of the present disclosure. As shown in FIG. 1, a deep learning model including a plurality of division models that each have a divided region-specific image (which may be referred to as a region image) as an input and a concatenation model that concatenates the outputs of such division models into one can be used. Each model can be trained simultaneously or separately.

Each division model outputs a corresponding feature vector by using an image of a region as an input, and the outputs of the division models are inputted to the concatenation model. That is, the concatenation model generates output by inputting region-specific feature vectors output from each division model. For example, when the face image is divided into six regions as shown in FIG. 1, images of the six regions are inputted to six division models and processed respectively, such as an image of the region 1 is inputted to the division model 1, an image of the region 2 is inputted to the division model 2, and so on. Each division model outputs a feature vector corresponding to a corresponding region image, and the concatenation model learns feature vectors for each region to generate a feature vector corresponding to a face image (for convenience of description, referred to as a mixed feature vector). Here, the value finally output through the concatenation model may be a value indicating which class the face image corresponds to, that is, a value indicating whose image the face image is. In this case, rather than the value output from the final layer in the plurality of layers constituting the concatenation model, the output value of the layer representing the feature of a face well among the layers before the final layer is used as the mixed feature vector. The mixed feature vector represents the overall features of the face.

Therefore, the feature vector (image feature vector) for the face image includes the region-specific feature vectors and the mixed feature vector.

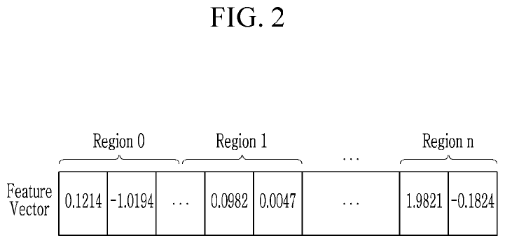

FIG. 2 is an exemplary view illustrating an image feature vector according to an exemplary embodiment of the present disclosure.

The feature vector obtained according to the embodiment of the present disclosure is a real value as shown in FIG. 2. In FIG. 2, region 0 represents a value of the mixed feature vector obtained through the concatenation model. Region 1 represents a value of a feature vector corresponding to the region 1 of the face image. Therefore, the image feature vector includes the feature vector of region 0, the feature vector of region 1, the feature vector of region 2, . . . , and the feature vector of region 6.

The image feature vector may be used for face recognition, face identification, face authentication, and the like.

In an embodiment of the present disclosure, an image feature vector is obtained using the deep learning model as described above, but the present disclosure is not limited thereto.

Similarity between feature vectors basically uses cosine similarity. If the similarity between feature vectors is large, they are likely to be faces of the same person, and if the similarity between feature vectors is small, they are likely to be faces of other people. Meanwhile, in an embodiment of the present disclosure, the similarity calculation between feature vectors may be performed for each face region, and the degree to which the face regions are masked is used to calculate the similarity between feature vectors. The face image may be partly masked by other objects such as ornaments. In consideration of this, in the embodiment of the present disclosure, weights are selectively assigned according to the degree of being masked for each face region. For example, a weight value may be assigned to the corresponding region when the value indicating the degree of being masked of a region among the six face regions is greater than a predetermined value, and the weight value may not be assigned when the value is smaller than the predetermined value. Alternatively, weights having different values may be assigned to each region according to the degree of being masked of each region. The greater the degree of being masked in the regions, the closer the weight can be set to zero, so that the weight has less influence on the similarity calculation. The manner of assigning weights is not limited to this. The value indicating the degree of being masked for each region may be calculated through various methods, such as using pixel values constituting the region.

For example, when calculating the similarity between feature vectors p and q of two face images, the similarity may be expressed as follows.

$$similarity ( p , q , w ) = {\sum }_{i = 0}^{n} sim ( {p}_{i} , {q}_{i} ) \times {ω}_{i} \qquad ( Equation 1 )$$

For example, when the face images is divided into six face regions, the region similarity between the feature vectors for each region is calculated for the two face images, and the similarity for the two face images is finally calculated by adding the values in which the region similarities are multiplied by the selectively given weight ωi. Here, i=0 may represent a feature vector (mixed feature vector) of the concatenation model, and i may represent a feature vector of each division model from 1 to n. The weight ω may have a value between 0 and 1. The larger the part masked in the face region, the closer ω is to zero, thus less affecting the similarity calculation. Similarity algorithm sim( ) can be used for cosine similarity or other algorithms. Although expressed as a sigma operation in Equation 1, other operations or additional operations may be included to apply ω.

Meanwhile, in the case of performing server-based face identification, the server has a plurality of feature vectors. If the number of feature vectors is large (e.g. hundreds of thousands or more), it will take a long time to find the owner of the feature vectors. In an embodiment of the present disclosure, a two-step process is performed to reduce a search time. Specifically, a quantization process of a feature vector and a search process using a cluster mapping table and a feature vector table are performed.

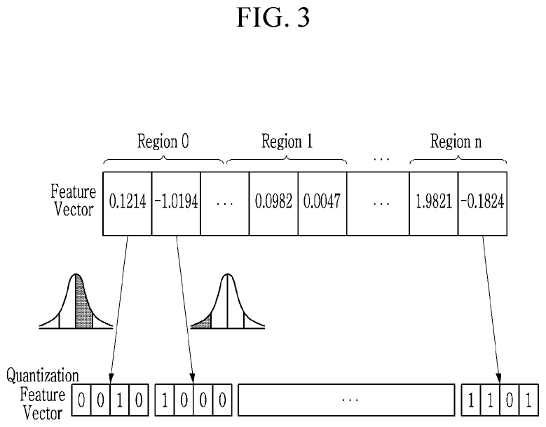

FIG. 3 is an exemplary view illustrating a quantization process according to an embodiment of the present disclosure.

In an embodiment of the present disclosure, the quantization method q(x) as shown in FIG. 3 may be used. The feature vector x consists of the real value xᵢ of the d-dimension. This is expressed as follows.

x=(x₁,x₂, . . . ,xᵢ, . . .,x_{d}), 1≤i≤d, x∈ [symbol] ^{d} (Equation 2)

Quantization vector c is a bit string as a result of q(x). This is expressed as follows.

c=q(x)=(c₁,c₂, . . . ,cᵢ, . . .,c_{d}) (Equation 3)

The distribution of all data for each term constituting the feature vector x is calculated, one term is divided into any number of sections, and the threshold of each section is set so that the distribution is to be a discrete uniform distribution. Values of the feature vectors may be quantized by assigning 1 to a section including a value of a feature vector and 0 to a section not including a value of a feature vector. Unlike this, 0 may be assigned to a section including a value of a feature vector, and 1 may be assigned to a section not including a value of a feature vector. In addition, a value of “1” or “0” may be assigned in various ways using a plurality of sections.

For example, given 1000 pieces of data for a random term xᵢ constituting the feature vector x, the distribution for xᵢ is calculated and then divided into a plurality of sections, for example, four sections, so that the distribution for x_{i i}s to be a discrete equal distribution. In this case, it is assumed that the result of setting the thresholds for each section so that 250 pieces of data are evenly distributed in each section is expressed by Equation 4 as follows.

xᵢ≤−1.2188, −1.2188<xᵢ≤0.0012, 0.0012<xᵢ≤1.1223, 1.1223<xᵢ (Equation 4)

If the value of xᵢ is 0.1214, in the above Equation 3, since it corresponds to the third section, the third bit is 1 and the remaining bits are 0, so that the final bit string cᵢ is 0010. The quantization feature vector consists of bit strings obtained through this quantization process for the feature vector.

Since feature vectors have different distribution tendencies for each term, sections are determined independently for each xᵢ constituting each feature vector, and the values of xᵢ are converted into a bit string using the determined sections. When a feature vector x having a d-dimension is converted into l bit strings for each term, the feature vector x becomes a quantization vector c having a length of d×l.

In an embodiment of the present disclosure, when searching a database in which a large amount of data for face recognition is stored, a cluster mapping table and a feature vector table are configured for faster searching.

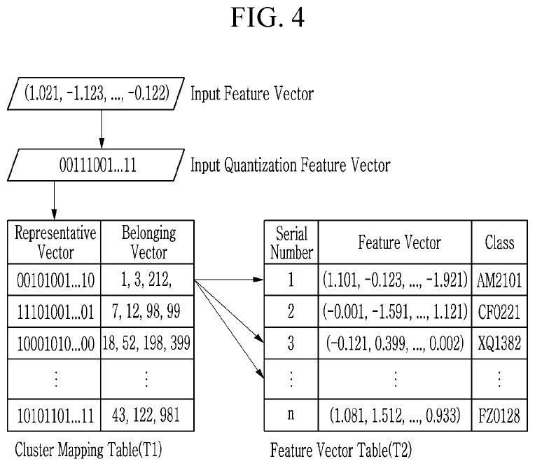

FIG. 4 is an exemplary diagram illustrating a cluster mapping table and a feature vector table according to an embodiment of the present disclosure.

A database according to an embodiment of the present disclosure includes a cluster mapping table and a feature vector table.

The feature vector table includes a serial number, a feature vector, and a class. The feature vector table stores the feature vectors of all users in the database. The serial number is the identifier of a record in the database. Here, the class is information indicating whose face image the face image is. For example, the class may indicate information of a person corresponding to the face image.

The process of searching for a face using only the feature vector table takes a long time because the similarity needs to be calculated as many times as the number of records in the feature vector table. Clustering is performed for efficient processing and then searching is performed in two steps.

For clustering, first, all feature vectors of the feature vector table are quantized to obtain a quantization feature vector. Since the quantization feature vector has reduced entropy compared to the feature vector, the quantization feature vectors may be the same even if the feature vectors are different.

A cluster mapping table represents feature vectors having the same quantization feature vector as one record.

The cluster mapping table includes a representative vector and a belonging vector. The representative vector is a quantization feature vector. The belonging vector is a serial number of a feature vector table having the same quantization feature vector.

If the size of the cluster mapping table is too large, it can be inefficient for searching. In this case, the cluster mapping table can be reduced by performing clustering between representative vectors.

For example, among the quantization feature vectors obtained for the plurality of face images, grouping is performed by grouping quantization feature vectors having the same value as one group. Next, a cluster mapping table is constructed as shown in FIG. 4 by assigning a representative vector to each group and mapping a belonging vector to the representative vector. For example, face images having quantization feature vectors of “00101001 . . . 10” are set as one group, and “00101001 . . . 10” is set as the representative vector of the group. Then, the belonging vector for the face images having the quantization feature vectors of “00101001 . . . 10” is mapped to the representative vector. Here, a serial number of face images belonging to the group is used as the belonging vector, but it is not necessarily limited thereto. Therefore, corresponding to the representative vector of “00101001 . . . 10”, “1, 3, 212”, which is a serial number of the face images belonging to the group, is mapped as the belonging vector.

A search for face recognition is performed using the cluster mapping table and the feature vector table. This will be described in more detail later.

Next, based on the region division of the face image, the feature vector acquisition, the quantization of the feature vector, the cluster mapping table, and the feature vector table as described above, a face recognition method and apparatus in which face images are processed to obtain the feature vectors, and the face search is performed based on the feature vectors, will be described.

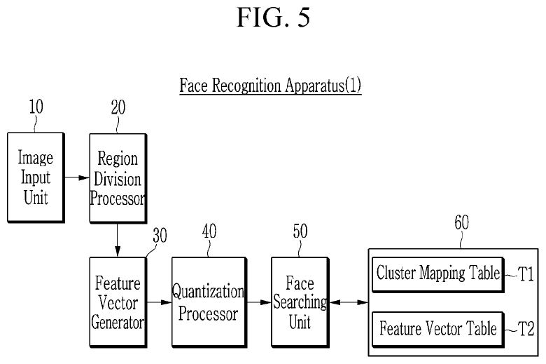

FIG. 5 is a diagram illustrating a structure of a face recognition apparatus according to an exemplary embodiment of the present disclosure.

As shown in FIG. 5, the face recognition apparatus 1 according to an exemplary embodiment of the present disclosure includes an image input unit 10, a region division processor 20, a feature vector generator 30, a quantization processor 40, a face searching unit 50, and a database 60.

The image input unit 10 is configured to receive a face image for face recognition.

The region dividing processor 20 is configured to divide the face image into a plurality of regions.

The feature vector generator 30 is configured to generate an image feature vector including a feature vector for each region of the input face image and a mixed feature vector.

The quantization processor 40 is configured to quantize the image feature vector consisting of a real value to generate a quantization feature vector consisting of a bit string.

The face searching unit 50 is configured to search for data corresponding to the input face image from the basic data stored in the database 60 by using the quantization feature vector, that is, search to find whose face image the input face image is. This search will be described in more detail later.

The database 60 is configured to store basic data for face recognition, and in particular, includes a feature vector table T1 and a cluster mapping table T2 for respective face images corresponding to the basic data.

Each component 10 to 40 and the database 60 of the face recognition apparatus 1 having such a structure may be implemented in a form included in one device, or may be implemented in a form included in different devices. For example, in the structure of a server/client, some parts (including a database) of the face recognition apparatus 1 may be implemented in a form of being included in a server or a client, and others may be implemented in a form of being included in a client or a server. For a specific example, the client is implemented in a form including the image input unit 10, and the server is implemented in a form including the region division processor 20, the feature vector generator 30, the quantization processor 40, the face search unit 50, and the database 60. Alternatively, the client may be implemented in a form including the image input unit 10, the region division processor 20, and the feature vector generator 30, and the server may be implemented in a form including the quantization processor 40, the face search unit 50, and the database 60.

Next, a face recognition method of processing a face image to obtain a feature vector and performing a face search based on the same will be described.

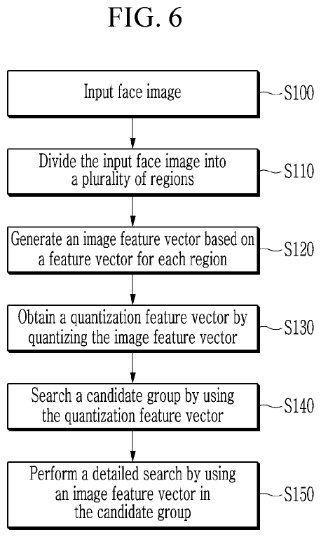

FIG. 6 is a flowchart illustrating a face recognition method according to an exemplary embodiment of the present disclosure.

As shown in FIG. 6, when a face image is input for face recognition (S100), the face recognition apparatus 1 divides the input face image into a plurality of regions (S110).

The face recognition apparatus 1 generates a feature vector for each region of the input face image, and generates an image feature vector using the generated feature vectors for each region (S120).

The face recognition apparatus 1 quantizes the image feature vector consisting of real values to generate a quantization feature vector consisting of a bit string (S130).

Thereafter, the face recognition apparatus 1 searches the database 60 by using the quantization feature vector of the input face image, and first, searches for a candidate group corresponding to the input face image (S140). Then, the face recognition apparatus 1 performs a detailed search of finding out whose image the input face image is (S150).

Referring to FIG. 4, the search process will be described in more detail as follows. For example, by using a quantization feature vector (input quantization feature vector in FIG. 4) obtained by quantizing an image feature vector (input feature vector in FIG. 4) of an input face image, a candidate mapping group is obtained by searching the cluster mapping table T1. To this end, the similarities between the quantization feature vector of the input face image, that is, the input quantization feature vector and the representative vectors of the cluster mapping table T1, are determined, and the representative vectors similar to the input quantization feature vector among the representative vectors of the cluster mapping table T1 are determined as the candidate group based on the similarities.

More specifically, when searching for the candidate group in step S140, similarity calculation is performed between the input quantization feature vector and representative vectors of the cluster mapping table T1 to obtain similarities, respectively, and at least one representative vector having the highest similarity among the representative vectors of the cluster mapping table is selected as the candidate group. In the similarity calculation, since the input quantization feature vectors are composed of bit strings, the sim( ) function uses a bitwise XOR operation (Bitwise Hamming Distance) between the input quantization feature vector and the representative vectors. The Bitwise XOR operation is faster than real calculations.

In operation S150, a detailed search is performed on the searched candidate group to find out whose image the input face image is. Specifically, a detailed search is performed on belonging vectors included in the representative vectors selected as the candidate group. In the detailed search, finding whose image is the input face image is performed based on the similarities between the belonging vectors included in the representative vector selected as the candidate group and the feature vectors of the input face image. In such a detailed search, a feature vector of real values is used instead of a quantization feature vector. Similarity calculation uses similarity (p, q, w).

For example, when the representative vector of “00101001 . . . 10” in the cluster mapping table T1 of FIG. 4 is selected as the candidate group, the feature vectors corresponding to the belonging vectors “1, 3, 212” belonging to representative vector of “00101001 . . . 10” are obtained from the feature vector table T2. The similarity between the image feature vector (input feature vector) of the input face image and the feature vectors corresponding to the belonging vector is calculated for each belonging vector. Specifically, similarity calculation is performed between the feature vectors (1.1001, −0.123, . . . , −1.921) corresponding to the belonging vector “1” and the input feature vector to obtain a similarity 1, and similarity calculation is performed between the feature vector (−0.121, 0.399, . . . , 0.002) corresponding to the belonging vector “3” and the input feature vector to obtain a similarity 2, and also similarity calculation is performed between the feature vector (not shown) corresponding to the belonging vector “212” and the input feature vector to obtain a similarity 3. The similarity 1, the similarity 2, and the similarity 3 for each belonging vector may be calculated based on Equation 1 described above.

After a plurality of similarities are obtained by performing similarity calculation between the image feature vector of the input face image and the feature vectors corresponding to the belonging vectors, respectively, the class closest to the image feature vector is selected using the obtained similarities. For example, the belonging vector corresponding to the similarity having the highest value among the similarity 1, the similarity 2, and the similarity 3 for each belonging vector is selected, and the class of the selected belonging vector is finally determined as the class corresponding to the input face image. The method of determining the class in the present disclosure is not limited thereto.

As described above, when searching a face image corresponding to the input face image from the database 60, instead of comparing all the feature vectors consisting of real values of the face images, the candidate group is first selected using a cluster mapping table, and a similarity calculation between the feature vectors included in the candidate group and the feature vectors of the input face image is performed to find a class corresponding to the input face image, thereby effectively reducing the search time.

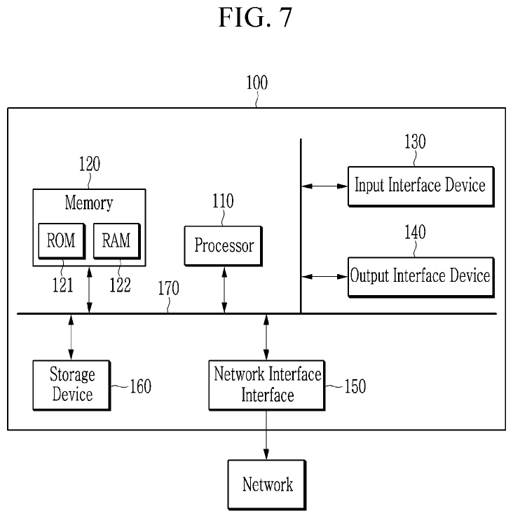

FIG. 7 is a structural diagram of a face recognition apparatus according to another embodiment of the present disclosure.

As shown in FIG. 7, the face recognition apparatus 100 according to another embodiment of the present disclosure may include a processor 110, a memory 120, an input interface device 130, an output interface device 140, a network interface device 150, and a storage device 160, which may communicate via a bus 170.

The processor 110 may be configured to implement the methods described above based on FIG. 1 to FIG. 6. The processor 110 may be configured to perform at least one function of, for example, a region division processor, a feature vector generator, a quantization processor, and a face search unit. The processor 110 may be a central processor (CPU) or a semiconductor device that executes instructions stored in the memory 120 or the storage device 160.

The memory 120 is connected to the processor 110 and stores various information related to the operation of the processor 110. The memory 120 may store instructions for execution in the processor 110 or temporarily load the instructions from the storage device 160. The processor 110 may execute instructions stored or loaded in the memory 120. The memory may include a read only memory (ROM) 121 and a random access memory (RAM) 122.

The storage device 160 may be configured to include a cluster mapping table and a feature vector table according to an embodiment of the present disclosure.

In an embodiment of the present disclosure, the memory 120 and the storage device 160 may be located inside or outside the processor 110. The memory 120 and the storage device 160 may be connected to the processor 110 through various known means.

The input interface device 130 may be configured to receive data provided to the processor 110. For example, the input interface device 130 may be configured to receive a face image and send it to the processor 110.

The output interface device 140 may be configured to output the processing result of the processor 110. For example, the output interface device 140 may be configured to output information about a class, provided by the processor 110, indicating whose face image the input face image is.

The network interface device 150 is configured to be connected to a network to transmit and receive a signal. For example, the network interface device 150 may be configured to transmit, via the network, information about a class, provided by the processor 110, indicating whose face image the input face image is.

According to an embodiment of the present disclosure, even when the input face image is masked by an arbitrary object, the face image can be effectively recognized.

In addition, a candidate group corresponding to the face image is selected by using a cluster mapping table in a large database, and the owner of the input face image is finally founded by determining similarity between feature vectors of real values in the selected candidate group, thereby reducing the search time for face recognition.

Exemplary embodiments of the present disclosure may be implemented through a program for performing a function corresponding to a configuration according to an exemplary embodiment of the present disclosure and a recording medium with the program recorded therein, as well as through the aforementioned apparatus and/or method, and may be easily implemented by one of ordinary skill in the art to which the present disclosure pertains from the above description of the exemplary embodiments.

Although the embodiments of the present disclosure have been described in detail above, the scope of the present disclosure is not limited thereto, and various modifications and improvements of the operator using the basic concepts of the present disclosure as defined in the following claims are also provided, which belong to the scope of rights.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A method of performing face recognition, comprising:
dividing, by a face recognizing apparatus, an input face image into a plurality of regions; and
generating, by the face recognition apparatus, a feature vector consisting of real values for each region of the input face image, and generating an image feature vector using the generated feature vectors for each region.

2. The method of claim 1, wherein
the generating of an image feature vector comprises
generating an image feature vector by using a deep learning model including a plurality of division models that receive images corresponding to each of the plurality of divided regions of the face image as region images and generate a feature vector for each region image, and a concatenation model that performs learning with outputs of the division models to output a mixed feature vector corresponding to the face image, wherein
the image feature vector comprises feature vectors for the region images of the divided regions and the mixed feature vector.

3. The method of claim 1, further comprising:
generating, by the face recognition apparatus, a quantization feature vector consisting of a bit string by quantizing the image feature vector;
finding, by the face recognition apparatus, a candidate group by searching a database using the quantization feature vector; and
performing, by the face recognition apparatus, a detailed search for finding a class indicating whose face image the input face image is by using the feature vectors included in the searched candidate group and the image feature vector.

4. The method of claim 3, wherein
in the finding of a candidate group and in the performing of a detailed search, a search is performed based on a similarity calculation between a quantization feature vector or an image feature vector corresponding to the input face image and feature vectors stored in the database, and the similarity calculation is performed for each region.

5. The method of claim 4, wherein
when calculating similarities between the quantization feature vector or the image feature vector and the feature vectors stored in the database, a similarity between feature vectors is calculated for each region, a similarity for each region is obtained by using a weight selectively assigned to the calculated similarity, and a final similarity is obtained by summing the similarity for each region, wherein the weight is selectively assigned for each region according to a degree to which a corresponding region is masked.

6. The method of claim 3, wherein
the finding of a candidate group comprises
selecting, as a candidate group, a group having a highest similarity to the quantization feature vector of the input face image from a cluster mapping table in which a plurality of face images are grouped based on quantization feature vectors.

7. The method of claim 6, wherein
the cluster mapping table includes a representative vector assigned to each group and a belonging vector mapping to the representative vector and representing a serial number of face images belonging to a corresponding group, wherein the representative vector includes one of quantization feature vectors of the plurality of face images, and
the selecting a group, as a candidate group, comprises
calculating a similarity between the representative vector of each group and the quantization feature vector of the input face image, respectively, and selecting a representative vector having a highest similarity as the candidate group based on the similarity calculation result for each representative vector of each group.

8. The method of claim 3, wherein
the performing of a detailed search comprises
finding an image feature vector having a highest similarity to the image feature vector of the input face image among image feature vectors corresponding to serial numbers included in the candidate group from a feature vector table in which image feature vectors of the plurality of face images are mapped to serial numbers.

9. The method of claim 8, wherein
the feature vector table is mapped to a class corresponding to the serial number and the class represents whose face image a corresponding face image is, and
the performing of a detailed search comprises
performing similarity calculation between the image feature vectors corresponding to the serial numbers included in the candidate group and the image feature vector of the input face image, respectively, and selecting a class mapped to an image feature vector corresponding to a serial number having a highest similarity based on the result of the similarity calculation.

10. The method of claim 3, wherein
the generating of a quantization feature vector comprises
performing a quantization process that converts a value of a feature vector into “1” or “0” according to whether the value of the feature vector is included in a section by using a plurality of sections set in advance for each feature vector included in the image feature vector.

11. The method of claim 10, wherein
one feature vector is composed of real values in a d-dimension, a plurality of sections are determined for each term constituting the real value, and a value of the term is converted into bits by using the sections determined for each term in the quantization process.

12. The method of claim 10, wherein
one term is divided into a plurality of sections and a threshold is set for each section so that a distribution of data for each term constituting the feature vector is to be a discrete uniform distribution.

13. An apparatus for performing face recognition, comprising:
an input interface device configured to receive a face image;
a storage device configured to include a database; and
a processor configured to perform face recognition processing on a face image provided from the input interface device, wherein
the processor is configured to divide the provided face image into a plurality of regions and generate a feature vector consisting of real values for each region of the provided face image, and generate an image feature vector using the generated feature vectors for each region.

14. The apparatus of claim 13, wherein
the processor is configured to generate the image feature vector by using a deep learning model including a plurality of division models that receive images corresponding to each of the plurality of divided regions of the provided face image as region images and generate a feature vector for each region image, and a concatenation model that performs learning with outputs of the division models to output a mixed feature vector corresponding to the provided face image, wherein the image feature vector comprises feature vectors for the region images of the divided regions and the mixed feature vector.

15. The apparatus of claim 13, wherein
the processor is further configured to generate a quantization feature vector consisting of a bit string by quantizing the image feature vector, find a candidate group by searching the database using the quantization feature vector, and perform a detailed search for finding a class indicating whose face image the provided face image is by using the feature vectors included in the searched candidate group and the image feature vector.

16. The apparatus of claim 15, wherein
the processor is specifically configured to perform a search based on a similarity calculation between a quantization feature vector or an image feature vector corresponding to the provided face image and feature vectors stored in the database, and the similarity calculation is performed for each region.

17. The apparatus of claim 16, wherein
the processor is specifically configured to, when calculating similarities between the quantization feature vector or the image feature vector and the feature vectors stored in the database, calculate a similarity between feature vectors for each region, obtain a similarity for each region by using a weight selectively assigned to the calculated similarity, and obtain a final similarity by summing the similarity for each region, wherein the weight is selectively assigned for each region according to a degree to which a corresponding region is masked.

18. The apparatus of claim 15, wherein
the database includes a cluster mapping table in which a plurality of face images are grouped based on quantization feature vectors and a feature vector table in which the image feature vectors of the plurality of face images are mapped to serial numbers, wherein
the cluster mapping table includes a representative vector assigned to each group and a belonging vector mapping to the representative vector and representing a serial number of face images belonging to a corresponding group, wherein the representative vector includes one of quantization feature vectors of the plurality of face images, and
the feature vector table is further mapped to a class corresponding to the serial number and the class represents whose face image a corresponding face image is.

19. The apparatus of claim 18, wherein
the processor is specifically configured to calculate a similarity between the representative vector of each group in the cluster mapping table and the quantization feature vector of the input face image, respectively, select a representative vector having a highest similarity as the candidate group based on the similarity calculation result for each representative vector of each group, perform similarity calculation between the image feature vectors corresponding to the serial numbers included in the candidate group based on the feature vector table and the image feature vector of the input face image, respectively, and select a class mapped to an image feature vector corresponding to a serial number having a highest similarity based on the result of the similarity calculation.

20. The apparatus of claim 15, wherein
the processor is specifically configured to perform a quantization process that converts a value of a feature vector into “1” or “0” according to whether the value of the feature vector is included in a section by using a plurality of sections set in advance for each feature vector included in the image feature vector, wherein
one feature vector is composed of real values in the d-dimension, a plurality of sections are determined for each term constituting the real value, and a value of the term is converted into bits by using the sections determined for each term in the quantization process.
